(19) United States
(12) Patent Application Publication
(10) Pub. No.: US 2007/0013170 A1
(43) Pub. Date: Jan. 18, 2007

(54) Portable universal adaptable wheel and handle assemblies for golf bag assembly unit

(75) Inventor: Dan Cardea, Villa Park, IL (US)

Correspondence Address: LEVENFELD PEARLSTEIN;Intellectual Property Department, 2 North LaSalle, Suite 1300, CHICAGO, IL, 60602, US

(73) Assignee: H3 Enterprises, L.L.C., Villa Park, IL (US)

(21) Appl. No.: 11/181,304

(22) Filed: Jul. 14, 2005

(51) Int. Cl. B62B 1/00

(52) U.S. Cl. 280/659

(57) ABSTRACT

The instant invention of a universal transport device comprises a portable universal wheel assembly and handle assembly for attachment by retaining holding loop straps and a buckle strap to a golf bag or similar bulky object to ease movement of the article. The wheel assembly is attached to the object with the securing straps. The handle assembly is attached to the article with compression plates applied to a fabric component of the article. The wheel assembly and handle assembly are separately attachable and detachable as needed.

### FIELD OF THE INVENTION

The present invention relates to a golf bag transport apparatus including a wheel assembly and a handle assembly to be attached to any golf bag to provide a golf bag assembly unit to allow easy transport of any golf bag, including a heavy golf bag. The wheel assembly and handle assembly when attached to a golf bag convert the golf bag to an easily transportable unit. The transportable unit can also be easily stowed on a riding golf cart, if the user uses a golf cart to ride on a golf course. The wheel assembly is attached to the golf bag by easily applied straps or other means for attachment to the golf bag. The handle assembly is attached to the lip of the golf bag by two compression plates, one plate fitting over the bag lip and one plate attached to the handle assembly shaft.

The golf bag assembly unit comprises the wheel assembly, the handle assembly, and the golf bag. The wheel assembly and handle assembly, when attached to the base and lip of the golf bag, do not add any bulk to the peripheral shell of the golf bag, and the entire weight of the golf bag is supported by the base plate of the wheel assembly unit. Thus, the assembled unit is easy to stow on a riding golf cart, and yet permits the user of the assembled golf bag assembly unit to utilize the assembled unit as a “pull” assembly unit to “walk” the golf course, depending on what the player desires.

### BACKGROUND OF THE INVENTION

A golf bag is considered standard equipment for any golfer. A golf bag with no contents can weigh six or more pounds. With additional items such as clubs, balls, tees, gloves, etc., the loaded golf bag can easily weigh from twenty to twenty-five pounds or more. The weight of the loaded golf bag is, therefore, quite heavy for a golfer to walk a golf course carrying a loaded golf bag. If the golfer uses a golf cart, the peripheral bulk of the loaded golf bag becomes a factor in placing the loaded golf bag on the riding golf cart, especially if two or more golfers are using the same riding golf cart with each golfer's golf bag and related accessories. The question of suitable room for all the equipment on the riding golf cart accordingly can become a factor for each golf cart rider.

Additionally, the peripheral bulk of a loaded golf bag, together with the factor of the loaded bag's weight, can increase the difficulty of transporting a loaded golf bag in an automobile trunk, especially in the trunks of smaller cars.

In view of the above, it is especially important, preferably, to not increase the peripheral bulk of a loaded golf bag by any system or mechanism to ease the transportation, user handling, storage, and/or utility of a loaded golf bag.

In the prior art, a number of systems and mechanisms have been devised and utilized for golf bags holding golf clubs and allowing for easy transport thereof. For example, U.S. Pat. No. 4,822,071 to Widegren discloses a golf bag unit with extendible and retractable traveling wheels mounted on a mounting device. The tubular mounting device surrounds the golf bag of flexible material, the mounting device having a bottom support plate for golf clubs. A control rod activates retraction and extension of the support legs for the travel wheels. In travel position, the support legs for the travel wheels form an angle of 72 degrees from the longitudinal plane of the tubular body of the device when the travel wheels are in an extended position. The travel wheels extend away from the tubular body in the travel position. On retraction of the support legs and travel wheels, the golf bag stands on the bottom support plate of the golf bag unit.

U.S. Pat. No. 5,924,709 to Yang discloses a golf bag and a base disk mounted onto the bottom of the golf bag. The base disk is provided with two wheel seats, each seat with a wheel. The base disk has at least one support leg extending from the base disk, whereby the golf bag can be stably placed on the ground to be in a standing position. The base disk is formed as a flat container for fitting the lower end of the golf bag therein.

U.S. Pat. No. 6,056,301 to Berliner, et al., discloses a golf bag having two retractable wheels wherein the golf bag has a peripheral bottom shell extending downward to contain the wheels. The peripheral shell has an open lower end with the pair of wheels retractably within the shell, the pair of wheels on an axle. A shaft extends from the upper end of the golf bag to engage the axle of the pair of wheels within the shell by a spring-locking mechanism wherein the pair of wheels can be retracted from an extended orientation.

U.S Pat. No. 6,554,299 B1 to Bartos discloses a wheel mechanism that is easily attached to and detached from a golf bag to permit easy movement of a golf bag with clubs for short distances. The wheels are easily attached to the golf bag by means of a strap that is fastened to encircle the bottom of the bag apparently by elastic pressure. The strap holds metal clips, which hold the wheeled mechanism in place on the bottom of the golf bag.

U.S. Pat. No. 6,802,515 B2 and U.S. Publication No. 2004/0046343 A1 to Sorenson discloses a pullable golf bag having deployable wheels wherein the golf bag has an activator comprising a frame, a handle, and a pair of retractable wheels on individual axles. The activator comprises a plurality of links, which, upon activation, cause the retractable wheels to be retracted upward from an extended outward rotating position to within the frame of the activator to be within protective pockets and away from the ground.

U.S. Publication No. 2004/0035728 A1 to Ortega discloses a golf bag having integrated wheels and an extended handle. The integrated wheels are attached to the base piece (202) of the golf bag and can be within indented areas of the base piece and secured to the base piece. In one embodiment, the fabric shell of the golf bag can be detached from the extended handle, as can the integrated wheels attached to the base piece, so the user can carry the golf bag conventionally with a carrying strap.

U.S. Publication No. 2003/0102643 A1 to Jung discloses·a golf bag with detachable wheels. The golf bag is in two semi-circular sections. The wheels are detachable and are stored within wheel storage areas within semi-circular sections of the golf bag with wheel insertion bars. In one embodiment, the wheel insertion bars are inserted into wheel insertion slots located in the golf bag and the wheels fit within cavities in the golf bag.

U.S. Publication No. 2004/0232635 A1 to Cheldin discloses a golf bag with a metal or plastic base capable of supporting the golf bag, the bag being of a lightweight durable material such as a fabric. The rigid base includes a hollow rod wherein an axle fits for a pair of wheel assemblies. Each wheel assembly is extendible away from and retractable toward the rigid base along the common axis of the hollow rod comprising the support for the axle. The design of the rigid base includes wheel recesses on each side of the rigid base, which at least partially, if not completely, accept the retracted wheels. Each wheel assembly includes a wheel and an axle, wherein each axle fits within a shaft from one side of the rigid base to the other side and the wheels rotate about a common axis. Each wheel assembly may be movable between a retracted position and the open position. The removal of each wheel assembly is performed by depressing a cylindrical post of a lock holding each wheel assembly in position on each axle to disengage each lock.

Accordingly, in the prior art, it is well known to provide a golf bag with extendible and retractable wheels attached thereto. In general, it is known to attach the wheels to the golf bag either by a separate device, which grasps the sides of the golf bag and positions the wheels apart from the structure of the golf bag (U.S. Pat. No. 4,822,071), or requires the golf bag structure to include a rotatable wheel component wherein the wheels may be separately detachable. The disadvantage of the separate device, which grasps the sides of the golf bag to secure wheels to the bag for easy transport, is the bulkiness of the resulting golf bag which hinders the easy transport of the loaded golf bag in car trunks and on riding golf carts. Similar problems occur with transportation of loaded golf bags with permanently attached wheeled structural components. Additionally, unless the golf bag is designed to include wheels as a detachable component of the structure of the golf bag, the provision of a wheel component to the golf bag without wheels can be a problem of support and attachment.

It is an object of the instant invention to provide a method and assemblies to provide a generally applicable device for wheel transport of any conventional golf bag without attached wheels and similar equipment without wheels. The instant invention provides golf bags with means of transport wherein a wheel assembly and a handle assembly are easily attached to any golf bag or similar transportable object without any modification of the object to provide ready movement of the object and, conversely, can be easily removed from the object without damage to the attached golf bag or similar object. The instant invention is not limited to golf bags, but its primary objective is to facilitate handling of heavy golf bags by a single individual without difficulty.

The instant invention accordingly also comprises a universally adaptable method of attaching the wheel assembly and handle assembly to the subject golf bag or similar object. The method of attachment comprises a buckle strap of suitable length to encompass the golf bag or similar object and four Velcro™ straps and buckle straps of suitable length to form holding loop straps with holding loops, which encompass and contain the subject golf bag as securely as required without any necessary modification of the structure of the conventional golf bag. The method of attachment may be any suitable retaining means. A wrapping strap can be a retaining means. The handle assembly is attached by a threaded knob and compression means. The operational advantages of the instant invention are that the invented device eliminates the need for an existing bulky apparatus that needs to be attached to the bottom of the golf bag and the instant invention can be easily attached to and removed from any conventional golf bag as the need for easy transport is determined. The golf bag assembly with wheel and handle assemblies, accordingly, can comprise a means of wheeled transport, or the golf bag can be carried without attachment of auxiliary wheels and handles, if such is desired.

### SUMMARY OF THE INVENTION

The invention relates to a novel golf bag assembly comprising a golf bag and a novel transport device comprising a wheel assembly and a handle assembly, each assembly being easily attached and removed from a golf bag. The invented assembly of a golf bag and device is particularly directed to an assembly of a golf bag and a novel transport device easily attached to and easily removed from a transportable object such as a golf bag to permit easy movement of the object. The invented golf bag and assembly unit is particularly directed to a golf bag assembly comprising a golf bag, a wheel assembly, and a handle assembly, the wheel assembly and handle assembly easily attached to and removed from a conventional golf bag wherein the method of attachment is typically non-permanent. The invention comprises a wheel assembly of a support base plate with slots having lug openings to anchor holding loop straps with holding loops to the base plate, a plurality of holding loop straps with holding loops anchored to the base plate, a support structure for two rotatable wheels attached thereto by two extendible wheel-support members, each rotatable wheel rotatably coupled to each support member on a pivot axle coupling to permit movement of each wheel to be turned sideways on retraction of each rotatable wheel and accompanying support structure to beneath the base plate. In transport mode, each extendible wheel-support member with coupled wheel is extended outward. Spring-locking mechanisms of a spring-loaded latch selectively lock each rotatable wheel in position for transport mode of the golf bag assembly unit. The invention further comprises a handle assembly comprising two compression plates, an extended shaft as a handle shaft attached to one compression plate and a threaded, T-shaped knob and compression member with an indented annular collar. The compression member secures the compression plate and handle shaft to the securing compression plate attached to the golf bag. The golf bag is a conventional golf bag of fabric construction.

### DESCRIPTION OF THE DRAWINGS

FIG. 1 is a perspective view of an embodiment of the golf bag assembly unit comprising the golf bag with the attached wheel assembly and the attached handle assembly, with the wheel-support members extended and the four holding loop retaining straps with holding loops and buckle strap in position around the retained golf bag.

FIG. 2 is a perspective view of the wheel assembly with extended wheel-support members and wheels in rotatable position, the support structure, and the base plate.

FIG. 3 is a perspective view of the wheel assembly structure without retracted wheel-support members and retracted wheels.

FIG. 4 is a perspective view of the wheel assembly with retracted wheel-support members and retracted wheels.

FIG. 5 is a perspective view of the wheel assembly wheels in storage position to be retracted within the support structure.

FIG. 6 is a perspective view of the wheel assembly wheels in extended travel position in rotatable mode.

FIG. 7 is a view of the base plate showing the strap buckle insertion slots.

FIG. 8 is a perspective view of the strap buckle and inserted holding loop strap.

FIG. 9 is a perspective view of the compression member of the handle assembly showing the indented annular collar and threaded component.

FIG. 10 is a perspective view of the first compression plate with threaded shaft for insertion of the compression member of the handle assembly.

FIG. 11 is a perspective view of the second compression plate with inlet slot for indented annular collar of the compression member of the handle assembly.

FIG. 12 is a perspective view of any alternative second compression plate with an alternative inlet space for insertion of the compression member and indented annular collar of the compression member.

FIG. 13 is an illustration of the insertion of the compression member into the alternative second compression plate that secures the handle assembly to the golf bag.

### DETAILS OF THE INVENTION

As shown in the drawings for purposes of illustration, the present invention consists of a golf bag assembly unit, comprising a golf bag, and novel transport assemblies comprising a novel wheel assembly and a novel handle assembly, which are easily individually attached and removed from a transportable object and permit easy movement of the object. The wheel assembly, in effect, “puts wheels” on the golf bag or transportable object and the handle assembly provides “handling mobility” to guide the wheeled unit. The two assemblies, in combination, operate to provide a portable universal material handling apparatus for bulky objects otherwise not easily handled such as loaded golf bags.

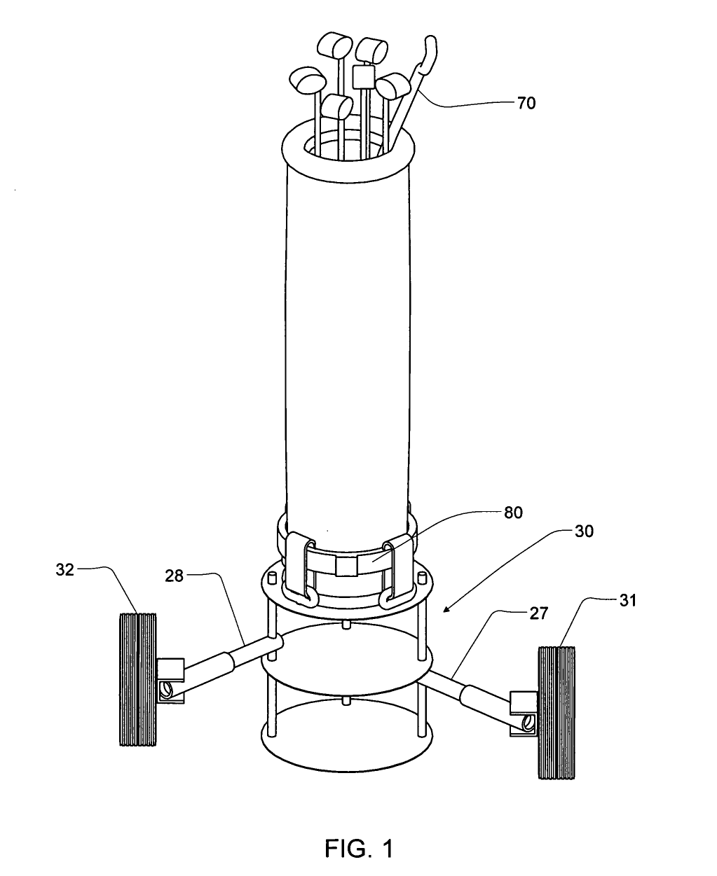

As shown in FIGS. 1, 2, and 3, an application of the portable universal wheel assembly and handle assembly system for transport is shown in an embodiment of the invented device as applied to a golf bag with clubs. The four holding loop straps with holding loops attached to the wheel assembly base plate to secure the golf bag to the wheel assembly can be buckle straps or retaining Velcro™ holding loop straps. A wrapping buckle strap of suitable length encompasses the golf bag or similar object and is inserted through the holding loops of the Velcro™ holding loop straps.

In an alternative embodiment, four double-faced Velcro™ straps can be used which attach to each other to form a holding enclosure around the golf bag. In an additional embodiment, one Velcro™ strap is an anchor strap for the other three Velcro™ straps. One anchor Velcro™ strap can be positioned in an upright posture from the base plate. The other three Velcro™ straps are then positioned to anchor to the anchor strap and to wrap the base of the golf bag to secure the golf bag to the wheel assembly.

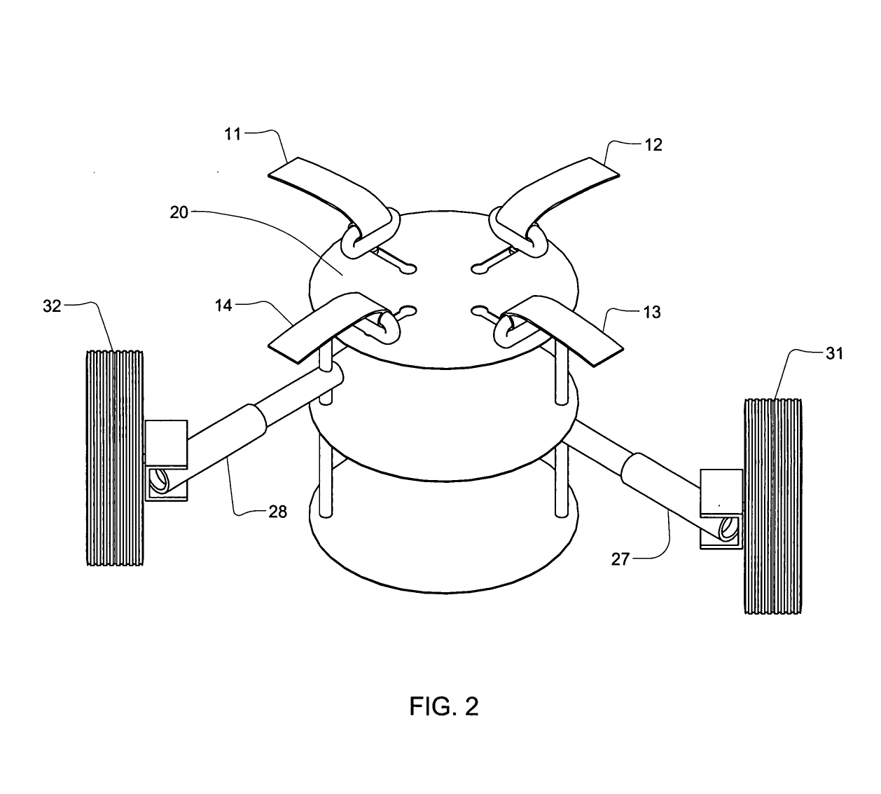

The handle assembly compression plates (not shown) engage the golf bag lip at the top of the bag and position the handle to extend from the golf bag for easy grasping by the user. The details of this embodiment are shown in FIGS. 2-13.

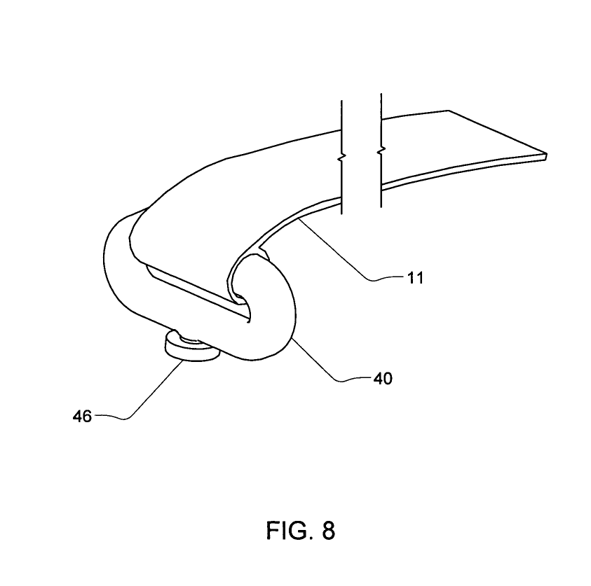

FIG. 2 illustrates the wheel assembly comprising the four buckle straps or Velcro™ straps (11, 12, 13, 14) attached to the base plate (20) by attachment buckle (40), as in FIG. 8. The wheel assembly structure (30) consists of the base plate (20) and two sub-plates (21, 22) separated by four support rods (23, 24, 25, 26) spaced equidistant to support the base plate (20) and the two sub-plates (21, 22); two wheel-support members (27, 28) engage the two support rods (23, 25) with spring-activated locking pins (not shown) of the spring-loaded latch mechanism to maintain the wheel-support members in extended position. The two rotatable wheels (31, 32) are coupled to wheel-support members (27, 28), each wheel on a pivot axis to permit movement of each wheel (31, 32) to be turned sideways from a folded position for storage within the wheel assembly structure (30) between the base plate (20) and the two sub-plates (21, 22) in vertical position for rotational movement.

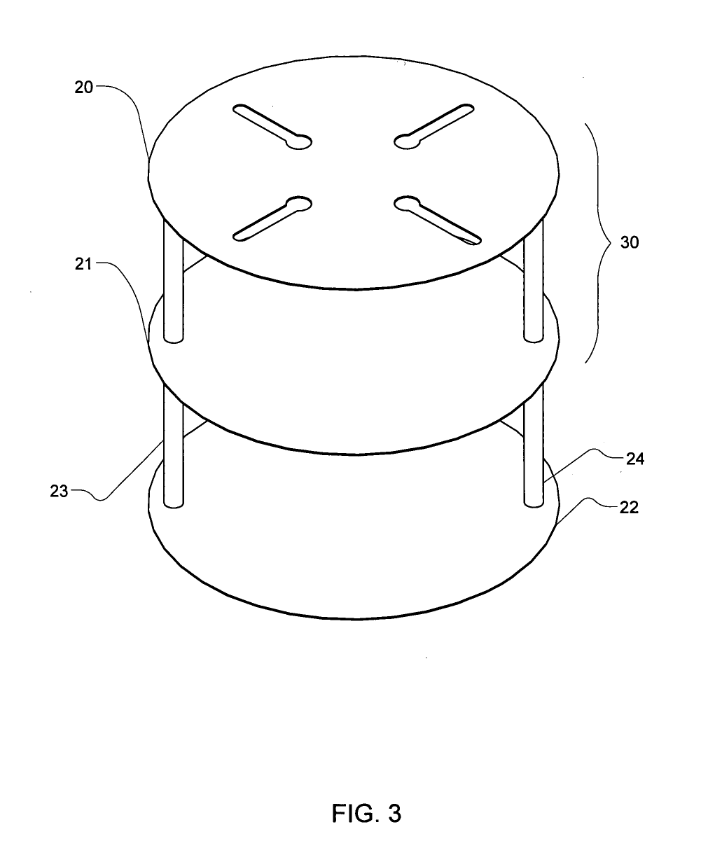

FIG. 3 illustrates the structure (30) of the wheel assembly without the attached wheel-support members (27, 28) and the two rotatable wheels (31, 32).

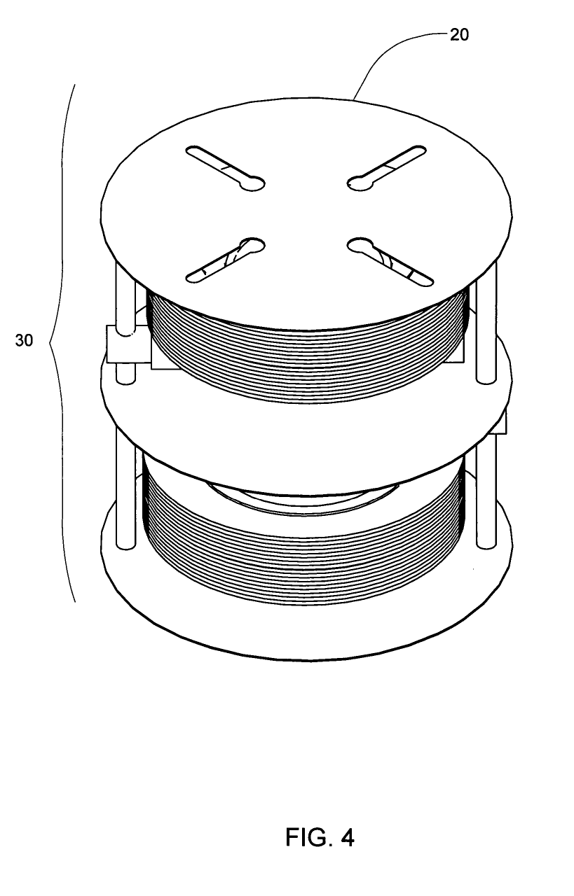

FIG. 4 illustrates the structure (30) of the wheel assembly with the rotatable wheels in folded position within the structure (30) between the base plate (20) and the two sub-plates (21, 22).

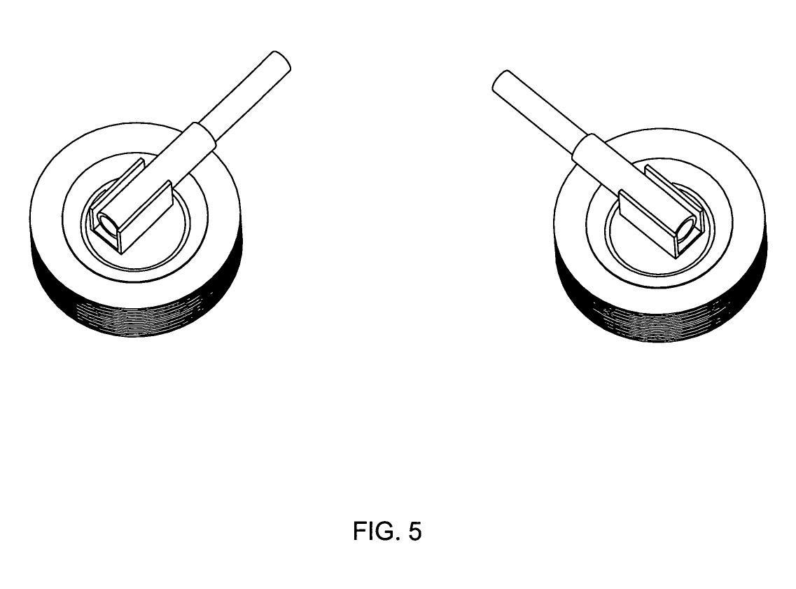

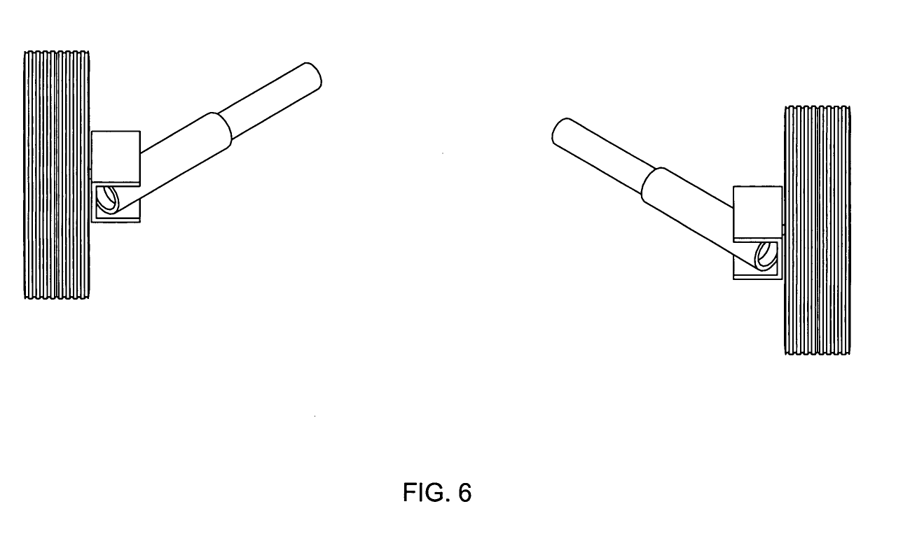

FIGS. 5 and 6 illustrate the wheel-support members and positioning of wheels (31, 32) in a folded position (FIG. 5) and in a vertical position (FIG. 6) wherein the wheels are coupled to each support member on a pivot axis in travel position.

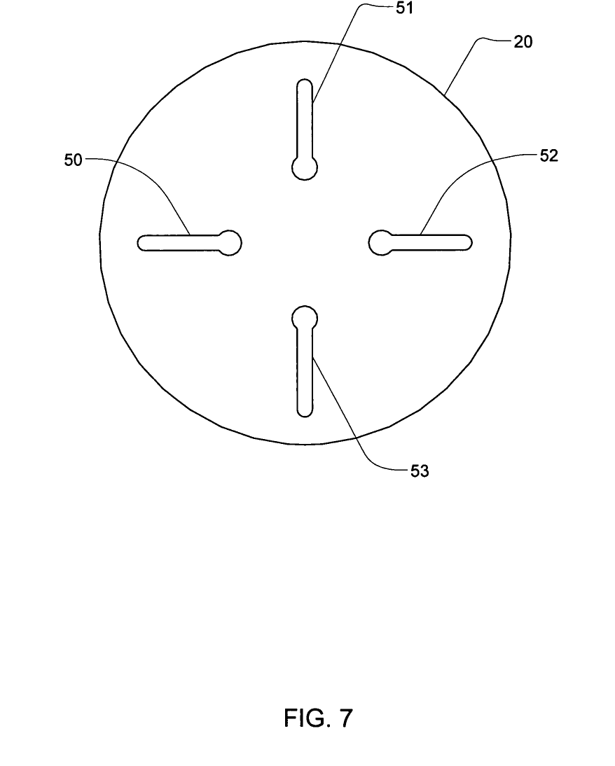

FIGS. 7 and 8 illustrate the structure of base plate (20) with four equi-spaced slots (50, 51, 52, 53) for receiving the attachment buckle pin (46) on the attachment buckle (40) (FIG. 8). Each buckle strap and Velcro™ holding loop strap (11, 12, 13, 14) engages an attachment buckle (40, 41, 42, 43). Each buckle strap and Velcro™ holding loop strap (11, 12, 13, 14) is secured to the base plate (20) by an engaged buckle pinned thereto within an appropriate slot. Each slot (50, 51, 52, 53) has an enlarged circular centered end to permit easy insertion and removal of the respective buckle pin on each attachment buckle (40, 41, 42, 43).

A wrapping buckle strap (80) is of suitable length to encompass the golf bag and is inserted through the holding loops of the Velcro™ holding loop straps (11, 12, 13, 14) to secure the holding loop straps to the golf bag.

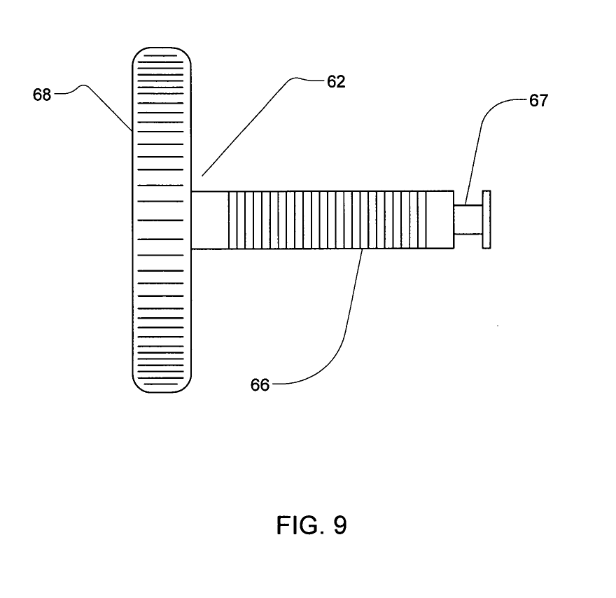

FIGS. 9-13 illustrate the handle assembly of the instant invention.

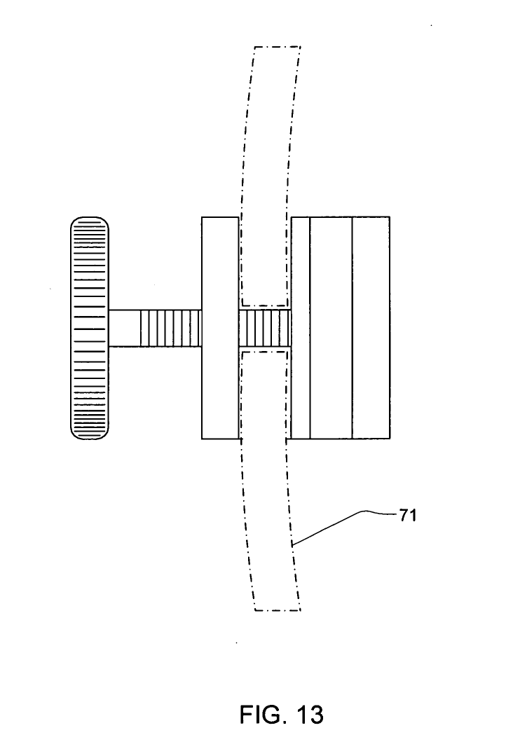

In operation, the two compression plates (60, 61) anchor the handle staff (70) to the golf bag lip (71) (FIG. 13). Either compression plate (60 or 61) is placed within the flexible material of the fabric shell of the golf bag in a location suitable for anchoring the handle staff (70) of the compression plate (60). Preferably the alternative compression plate (61), the securing compression plate, is placed within the fabric shell of the golf bag. The compression member (62) comprises a T-shaped structure with a knurled knob (65) on one end and a threaded bolt (66) with an indented annular collar (67) on the engagement other end. The compression plate (61) has an inlet slot (67) for inserting the indented annular collar (67) of the compression member (62). The indented annular collar (67) fits an exterior surface of the alternative compression plate (61). The threaded bolt (66) of the compression member (62) threads through the threaded opening (71) of the compression plate (60) to be inserted through the slot (67) of the alternative compression plate (61) so as to anchor the compression plate (60) to the alternative compression plate (61) by the compression member (62) to engage the compression plate (60) with the alternative compression plate (61) to cause a compression engagement of the handle assembly with the lip of the golf bag (71) and thereby attach the handle staff (70) of the handle assembly to the golf bag.

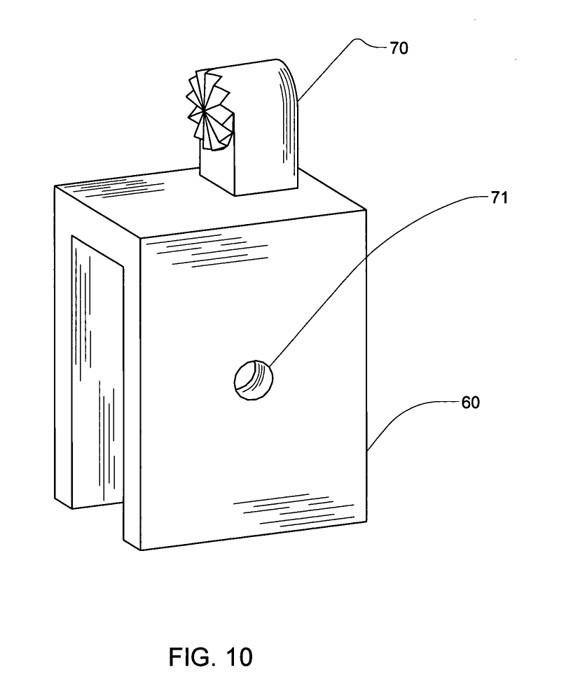

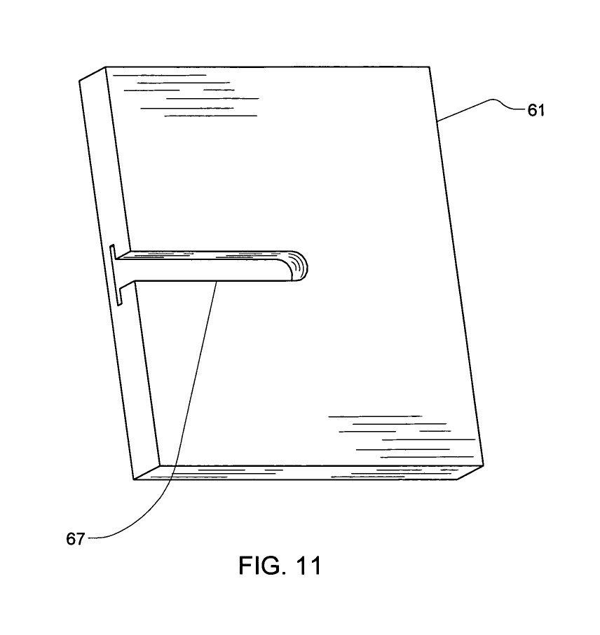

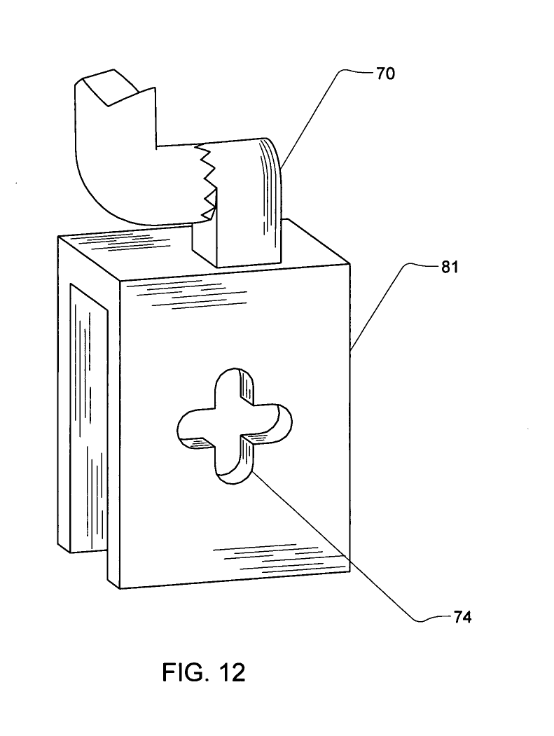

FIGS. 12-13 illustrate an alternative compression plate (61) for the securing the plate of FIG. 11 wherein the inlet slot (67) is replaced with four cornered openings (74) for insertion of the indented annular collar (67) of the compression member (62). The handle staff (70) is attached to the alternative compression plate (61) instead of the compression plate (60), as in FIG. 10.

FIG. 13 illustrates a method for attachment of the two compression plates (60, 61) to the fabric lip of the golf bag (71).

The body of the golf bag is an ordinary bag body for receiving golf clubs and can have various forms, such as additionally providing a pocket for receiving golf balls in the golf bag. The golf bag has an open upper end and a closed lower end. The golf bag often includes a shoulder strap. The closed lower end supports the contained golf clubs.

In use of the golf bag assembly unit of the instant invention, the closed lower end of the golf bag rests upon the support base plate (20) of the wheel assembly (30) and is supported thereon. The wheel assembly (30) is attached to the golf bag with the contained golf clubs by placing the retaining Velcro™ holding loops straps around the outside perimeter of the lower portion of the retained golf bag and wrapped around the golf bag by inserting the wrapping buckle strap (80) through the holding loops of the Velcro™ holding loop straps.

Attachment of the wheel assembly in this manner provides a secure fastening of the wheel assembly to the golf bag, but which is easily attached as needed.

The handle assembly is positioned on the golf bag so the handle staff projects from the interior or exterior of the golf bag, depending upon the construction of the bag. The handle assembly mode of attachment is such that the two compression plates are interchangeable as to either plate being within the fabric shell of the golf bag. The mode of attachment will be within the preference of the user.

As to the manner of usage and operation of the instant invention, it is apparent that the golf bag assembly unit has several advantages and qualities of use which include:
(a) easy storage while on or off the golf bag;
(b) can be accommodated in the space available for travel in an automobile;
(c) provides easy access to the complete diameter of the golf bag while attached to the golf bag; and
(d) allows easy removal of the wheel assembly and handle assembly, if desired.

The instant invention accordingly comprises a golf bag assembly unit comprising a golf bag and portable universal transport assemblies comprising a wheel assembly and a handle assembly easily attached and detached from said golf bag wherein said golf bag assembly comprises: (a) a golf bag; (b) a wheel assembly comprising a support structure comprising three circular metal plates, including a base plate, joined by three right angled support members to form a three layered housing with two wheel pockets for retained rotatable wheels and retained wheel-support members within said layered housing: (i) the wheel assembly comprising two rotatable wheels, each mounted on a pivot axis to each of two wheel support members attached to said wheel support structure, (ii) the wheel assembly comprising two wheel-support members each comprising a metal shaft as a first stage arm to engage a wheel assembly support structure member by a pivotable coupling to said support structure member, and a second stage arm as an extendible metal sleeve on said first stage arm to engage individually one of said rotatable wheels on a pivotable axle, wherein each said wheel pivots on said axle to a sideways position and to an upright position and is locked into position by a spring-loaded latch on second stage arm, (iii) the wheel assembly comprising four retaining holding loop straps with holding loops attached by slidable buckles to top circular metal plate of said wheel assembly support structure as base plate of said wheel assembly support structure, said base plate having four slots arranged 90 degrees apart on surface with lug openings to receive lug projections on said slidable buckles, (iv) a wrapping buckle strap of suitable length to encompass said golf bag; and (c) the handle assembly comprising a handle housing compression plate with an extended handle shaft, a rotatable compression member with indented annular collar on one end of the compression shaft and rounded projecting shoulder on opposite end of said compression shaft, a securing compression plate with inlet slot which receives indented annular collar of said compression shaft wherein four retaining holding loop straps attached to said base plate by slidable buckles comprises Velcro™ attachment straps and buckle straps, wherein said wrapping buckle strap is inserted through holding loops of said four retaining holding loop straps wherein said golf bag is of flexible fabric material, wherein said base plate of said support of structure supports the weight of the golf bag, wherein spring locking mechanisms of said spring loaded latch selectively lock each rotatable wheel in position in the transport mode of the golf bag assembly unit, and wherein each rotatable wheel is rotatably coupled to each support member of said wheel assembly by a pivot axle coupling to permit sideways movement of each wheel on retraction of the rotatable wheel and accompanying support structure to beneath said base plate.

It is also apparent that modifications and variations in the manner of operation, assembly, and use are readily obvious to one skilled in the art. It is understood, therefore, that within the scope of the appended claims, its invention may be practiced otherwise than specifically described.

What is claimed is:

1. A golf bag assembly unit comprising a golf bag and portable universal transport assemblies comprising a wheel assembly and a handle assembly easily attached and detached from said golf bag wherein said golf bag assembly unit comprises:
(a) a golf bag;
(b) a wheel assembly comprising a support structure comprising three circular metal plates, including a base plate, joined by three right angled support members to form a three layered housing with two wheel pockets for retained rotatable wheels and retained wheel-support members within said layered housing:
(i) said wheel assembly comprising two rotatable wheels, each mounted on a pivot axis to each of two wheel-support members attached to said wheel support structure,
(ii) said wheel assembly comprising two wheel-support members each comprising a solid metal shaft as a first stage arm to engage a wheel assembly support structure member by a pivotable coupling to said support structure member, and a second stage arm as an extendible metal sleeve on said first stage arm to engage individually one of said rotatable wheels on a pivotable axle, wherein each said wheel pivots on said axle to a sideways position and to an upright position and is locked into position by a spring-loaded latch on second stage arm,
(iii) said wheel assembly comprising four retaining holding loop straps with holding loops attached by slidable buckles to top circular metal plate of said wheel assembly support structure as base plate of said wheel assembly support structure, said base plate having four slots arranged 90 degrees apart on surface with lug openings to receive lug projections on said slidable buckles, and
(iv) a wrapping strap of sufficient length to encompass said golf bag;
(c) a handle assembly comprising a handle housing compression plate with an extended handle shaft, a rotatable compression member with indented annular collar on one end of the compression shaft and rounded projecting shoulder on opposite end of said compression shaft, a securing compression plate with inlet slot which receives indented annular collar of said compression shaft.

2. The golf bag assembly unit of claim 1 wherein four retaining holding loop straps with holding loops attached to said base plate by slidable buckles comprises Velcro™ attachment straps and buckle straps.

3. The golf bag assembly unit of claim 1 wherein said golf bag is of flexible fabric material.

4. The golf bag assembly unit of claim 1 wherein said base plate of said support of structure supports the weight of the golf bag.

5. The golf bag assembly unit of claim 1 wherein spring-locking mechanisms of said spring-loaded latch selectively lock each rotatable wheel in position in the transport mode of the golf bag assembly unit.

6. The golf bag assembly unit of claim 1 wherein each rotatable wheel is rotatably coupled to each support member of said wheel assembly by a pivot axle coupling to permit sideways movement of each wheel on retraction of the rotatable wheel and accompanying support structure to beneath said base plate.

7. A portable universal transport apparatus for easy movement of handleable articles including heavy golf bags containing equipment comprising:
(a) a wheel assembly support structure comprising three circular metal plates joined by three right angled support members to form a three layered housing with two wheel pockets for retained rotatable wheels and retained wheel-support members within said layered housing;
(b) two rotatable wheels, each mounted on a pivot axis to each wheel-support member attached to said wheel support structure;
(c) two wheel-support members each comprising a solid metal shaft as a first stage arm to engage a wheel assembly support structure member by a pivotable coupling to said support structure member, and a second stage arm as an extendible metal sleeve on said first stage arm to engage individually one of said rotatable wheels on a pivotable axle, wherein each said wheel pivots on said axle to a sideways position and to an upright position and is locked into position by a spring-loaded latch on second stage arm;
(d) four retaining holding loop straps with holding loops attached by slidable buckles to top circular metal plate of said wheel assembly support structure as base plate of said wheel assembly support structure, said base plate having four slots arranged 90 degrees apart on surface with lug openings to receive lug projections on said slidable buckles;
(e) a wrapping buckle strap of suitable length to encompass a golf bag and inserted through holding loops of said retaining holding loop straps; and
(f) a handle attachment assembly comprising a handle housing compression plate with an extended handle shaft, a rotatable compression member with indented annular collar on one end of the compression shaft and rounded projecting shoulder on opposite end of said compression shaft, a securing compression plate with inlet slot which receives indented annular collar of said compression shaft.

8. The transport apparatus of claim 7 wherein said four retaining holding loop straps mounted on said base plate by slidable buckles comprise Velcro™ attachment straps and buckle straps.

9. A golf bag assembly unit comprising a golf bag and portable universal transport assemblies comprising a wheel assembly and handle assembly easily attached and detached from said golf bag wherein said golf bag assembly unit comprises:
(a) a golf bag,
(b) a wheel assembly, and
(c) a handle assembly,
wherein said wheel assembly is secured to said golf bag by four double-faced Velcro™ straps which attach to each other to form a holding enclosure around said golf bag.

10. A golf bag assembly unit comprising a golf bag and portable universal transport assemblies comprising a wheel assembly and handle assembly easily attached and detached from said golf bag wherein said golf bag assembly unit comprises:
(a) a golf bag,
(b) a wheel assembly, and
(c) a handle assembly,
wherein said wheel assembly is secured to said golf bag by one Velcro™ strap as an anchor strap for three other Velcro™ straps wherein one Velcro™ strap is positioned in an upright posture and the other three Velcro™ straps are positioned to anchor to said anchor strap and to wrap the base of the golf bag to secure the golf bag to the wheel assembly.
